(19) United States
(12) Patent Application Publication
(10) Pub. No.: US 2020/0388173 A1
(43) Pub. Date: Dec. 10, 2020

(54) INTERACTIVE APPARATUS THAT CONNECTS TO ACTION-BASED ACCESSORIES

(71) Applicant: Character Labs, LLC, Irvine, CA (US)

(72) Inventor: Danielle LaBriola, Coto de Caza, CA (US)

(73) Assignee: Character Labs, LLC, Irvine, CA (US)

(21) Appl. No.: 16/433,315

(22) Filed: Jun. 6, 2019

(51) Int. Cl. G09B 1/06; G09B 19/00; A63H 3/02

(52) U.S. Cl. CPC G09B 1/06; A63H 3/02; G09B 19/00

(57) ABSTRACT

An interactive apparatus has an outer fabric that forms a shape of an organism. Further, the interactive apparatus has a flexible material engulfed by the outer fabric. A plurality of connectors adheres to the outer fabric. Each of the plurality of connectors corresponds to a predefined time interval of a predefined time duration. Further, each of the plurality of connectors connects to one of a plurality of action-based accessories upon completion of a corresponding action. The predefined time interval, the predefined time duration, and the corresponding action are indicated by a plurality of action-based indicia. The plurality of action-based indicia is located remotely from the outer fabric.

### BACKGROUND

### 1. Field

This disclosure generally relates to interactive devices. More particularly, the disclosure relates to an interactive device that connects to a plurality of accessories.

### 2. General Background

Teaching children, and even adults, a particular character trait can be a challenging task. For example, parents and educators often attempt to instill various character traits within children. The conventional approach is to tell children about the foregoing traits, and expect them to implement those traits on a day-to-day basis.

Yet, the conventional approach is typically ineffective. Being a recipient of information about character traits may allow children to regurgitate such information in a testing environment, but is not conducive to children adopting those character traits for themselves.

### SUMMARY

In one embodiment, an interactive apparatus has an outer fabric that forms a shape of an organism. Further, the apparatus has a flexible material engulfed by the outer fabric. Finally, the apparatus has a plurality of connectors adhered to the outer fabric. Each of the plurality of connectors corresponds to a predefined time interval of a predefined time duration. Moreover, each of the plurality of connectors connects to one of a plurality of action-based accessories upon completion of a corresponding action. The predefined time interval, the predefined time duration, and the corresponding action are indicated by a plurality of action-based indicia. The plurality of action-based indicia is located remotely from the outer fabric.

In an alternative embodiment, a method is provided. The method shapes an outer fabric according to a shape of an organism such that the outer fabric engulfs the flexible material. Further, the method adheres a plurality of connectors to the outer fabric.

Each of the plurality of connectors corresponds to a predefined time interval of a predefined time duration. Moreover, each of the plurality of connectors connects to one of a plurality of action-based accessories upon completion of a corresponding action. The predefined time interval, the predefined time duration, and the corresponding action are indicated by a plurality of action-based indicia. The plurality of action-based indicia is located remotely from the outer fabric.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1A illustrates an example of an outer fabric that is used to construct the interactive apparatus.

FIG. 1B illustrates the outer fabric edges being adhered together via the seam after the flexible material has been inserted into the interactive apparatus.

FIG. 1C illustrates a connector being adhered to the interactive apparatus.

FIG. 1D illustrates connectors being positioned along the branches, rather than the trunk, of the tree.

FIG. 2 illustrates a variety of action-based indicia that indicate actions associated with the trait to be developed via the interactive apparatus illustrated in FIGS. 1A-1D.

FIG. 3A illustrates an example of the action-based accessory being a leaf.

FIG. 3B illustrates the action-based accessory having a connector that attaches to the connector on the interactive apparatus.

FIG. 4A illustrates the action-based accessory, in the form of a leaf, being adhered to a connector on the interactive apparatus.

FIG. 4B illustrates all of the connectors being adhered to corresponding action-based accessories, thereby indicating to the user completion of trait development associated with the particular interactive apparatus over the predefined time interval.

FIG. 5A illustrates the lady bug having one or more connectors that attach to action-based accessories in the form of attachable spots.

FIG. 5B illustrates a connector that may be positioned on the rear side of the action-based accessory.

FIG. 6A illustrates the interactive apparatus having one or more connectors underneath one or more wings.

FIG. 6B illustrates a connector that may be positioned on the rear side of the action-based accessory.

FIG. 7 illustrates a process that may be used to compose the interactive apparatus illustrated in FIGS. 1A-1D and 3A-6B.

### DETAILED DESCRIPTION

An interactive apparatus connects to a plurality of action-based accessories, which induce development of a character trait over a predefined time period. In contrast with prior approaches, the interactive apparatus allows a child, or adult, to learn a character trait via a tangible medium having a plurality of action-based indicia, perform a plurality of actions corresponding to that character trait over the predefined time period, and interact with the interactive apparatus to validate performance of the plurality of actions at predefined intervals of the predefined time period. By iteratively performing the various actions corresponding to the character trait over the predefined time period, and validating such actions via the interactive apparatus, a user may proactively develop a character trait in a practical manner.

In one embodiment, the interactive apparatus is formed in the shape of an organism (e.g., human being, animal, plant, etc.). In an alternative embodiment, the interactive apparatus is formed in a shape other than of an organism. For example, the interactive apparatus may be formed in the shape of an organ of the organism (e.g., a heart), or in the shape of an object that is not an organism (e.g., an inanimate object, an emblem, etc.).

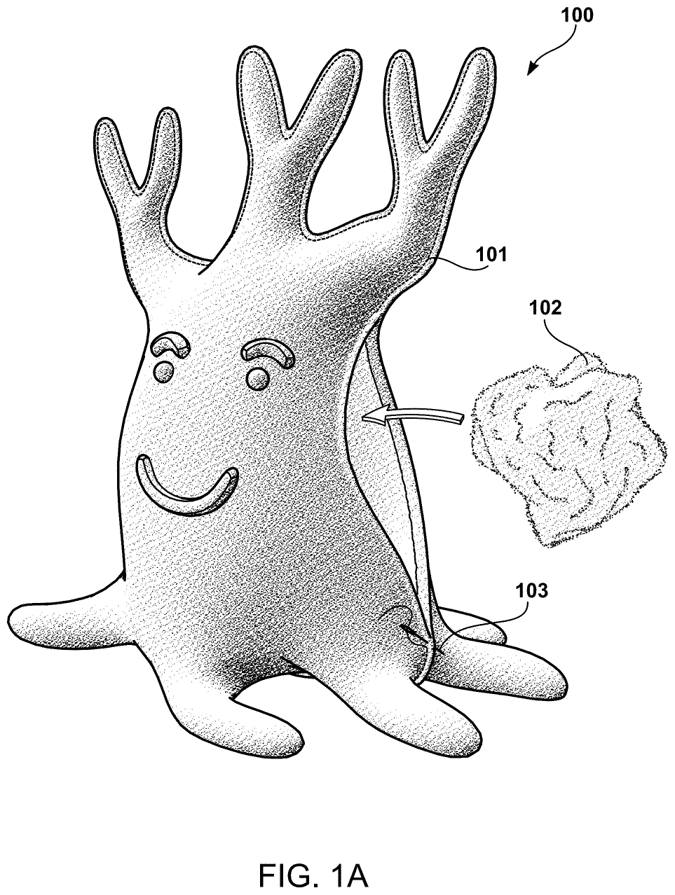

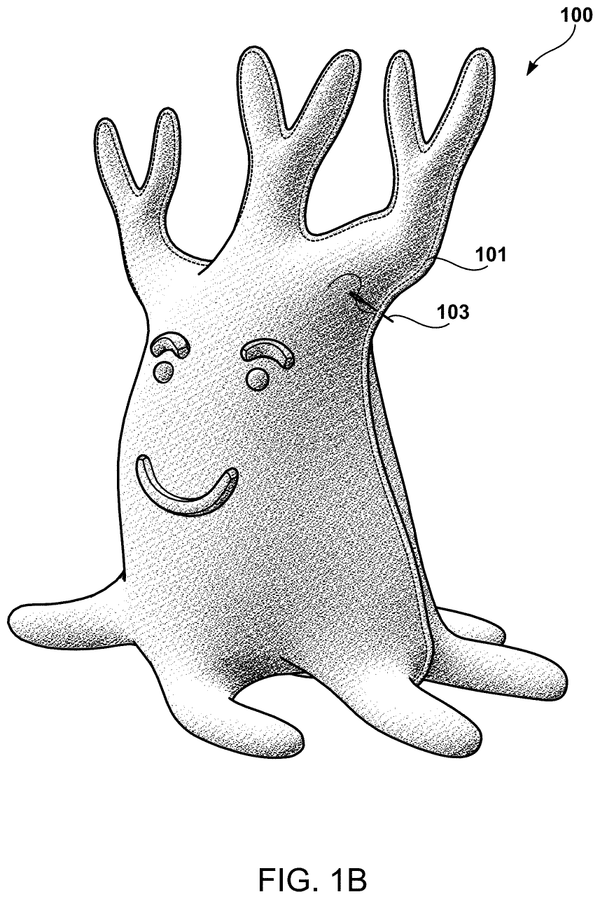

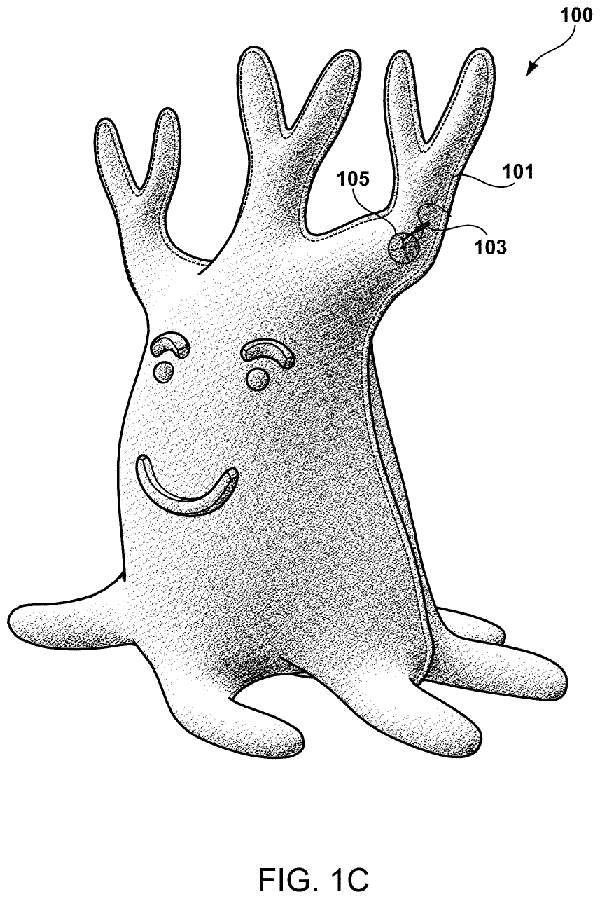

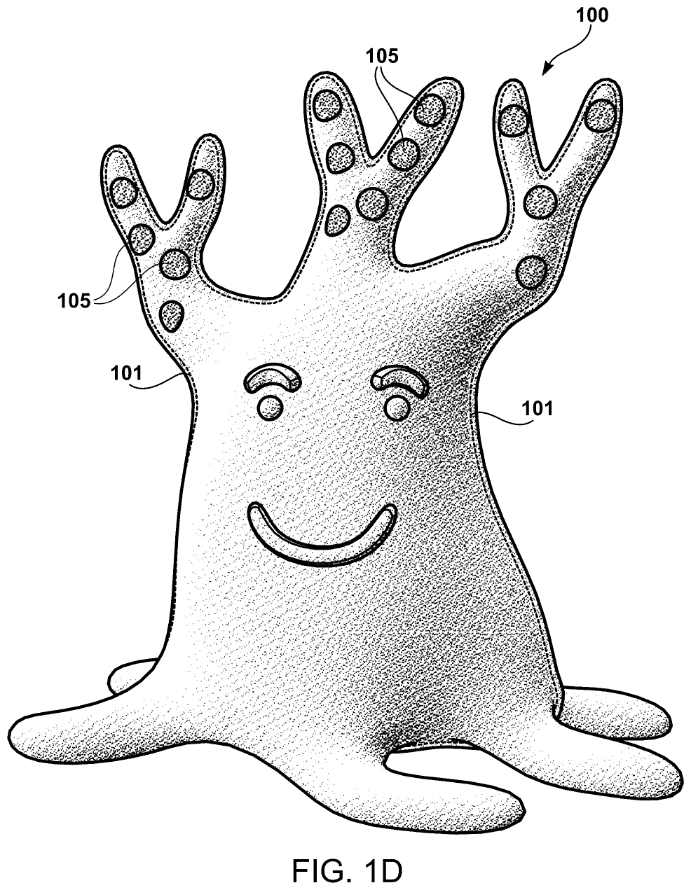

FIGS. 1A-1D illustrate a process for constructing an interactive apparatus 100. As an example, a tree may be the organism that is used for the shape of the interactive apparatus 100. In particular, FIG. 1A illustrates an example of an outer fabric that is used to construct the interactive apparatus 100. The outer fabric may be selected from a variety of fabrics, such as, for example, plush, terrycloth, flannel, cotton, silk, corduroy, velvet, and polyester. The interactive apparatus 100 may have one or more edges that are adhered together via one or more seams 101. Prior to the edges being adhered together via the seam 101, a flexible material 102, such as, for example, synthetic fiber, polyester fiberfill, cotton, silk, and/or or wool may be inserted into the outer fabric. As a result, the outer fabric engulfs the flexible material 102. FIG. 1B illustrates the outer fabric edges being adhered together via the seam 101 after the flexible material 102 has been inserted into the interactive apparatus 100. As an example, a needle 103 may be used to sew together the edges of the outer material. In an alternative embodiment, a non-flexible material may be used in place of the flexible material 102.

Furthermore, FIG. 1C illustrates a connector 105 being adhered to the interactive apparatus 100. As an example, the connector 105 may be one portion of a hook-and-loop fastener. As yet another example, the connector 105 may be a clip. (The foregoing connectors 105 are provided only as examples, since other types of connectors 105 may be used instead.) The connector 105 may be adhered to the interactive apparatus 100 in a variety of different ways such as, for example, sewn via the needle 103, glued via an adherent, etc.

Moreover, the connectors 105 may be adhered to the interactive apparatus 100 in a predetermined pattern. In the example of the tree, the connectors 105 may be positioned along the branches of the tree, rather than the trunk of the tree, as illustrated by FIG. 1D. Further, the connectors 105 may be positioned at predetermined distances from one another, in predetermined quantities on each branch, or in other predetermined patterns. Alternatively, the connectors 105 do not have to be positioned in any of foregoing ways.

Further, each of the connectors 105 may correspond to a predefined time interval of a predefined time duration. For example, the predefined time duration may be fifteen days, and the predefined time interval may be one day. Accordingly, fifteen connectors 105 may be adhered to the interactive apparatus 100 to allow for a user to connect an accessory on each day of a fifteen day time period to the interactive apparatus 100. By encouraging activity associated with a trait corresponding to the interactive apparatus 100 (e.g., environmental awareness corresponding to the tree), the accessories attached to the connectors 105 may help develop the corresponding trait through an iterative approach.

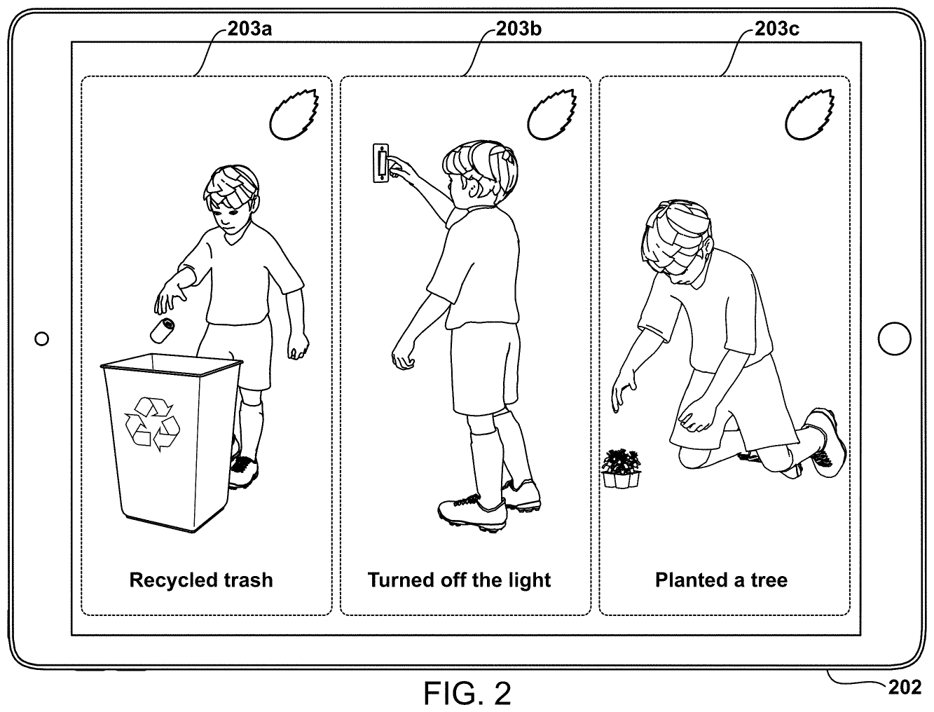

In addition, FIG. 2 illustrates a variety of action-based indicia 203a-c that indicate actions associated with the trait to be developed via the interactive apparatus 100 illustrated in FIGS. 1A-1D. In one embodiment, the action-based indicia 203a-c are located remotely from the interactive apparatus 100. For example, the action-based indicia 203a-c may be depicted (e.g., via imagery, text, etc.) on a tangible medium that is not integrated within the interactive apparatus 100. For instance, the action-based indicia 203a-c may be displayed on a display screen of a computing device 202 (e.g., personal computer, laptop, smartphone, tablet device, virtual reality headset, augmented reality headset, smartwatch, smart wearable, holographic projector, etc.). The action-based indicia 203a-c may be displayed by the computing device 200 in isolation, or as part of an e-book, game, etc. Alternatively, the tangible medium may be a paper-based medium such as, for example, a book.

In essence, the plurality of action-based indicia may be associated with a plurality of rules that restrict the plurality of action-based accessories from being connected via the plurality of connectors 105 to the outer fabric unless the corresponding action has been completed remotely from the outer fabric.

In another embodiment, the action-based indicia 203a-c are displayed in an integrated manner within the interactive apparatus 100. As another example, a display screen may be positioned within the trunk of the tree illustrated in FIGS. 1A-1D. The display screen may display the action-based indicia 203a-c while the user is using the interactive apparatus 100. For example, the user may provide inputs (e.g., touch-based) on the display screen of the interactive apparatus 100 to learn about different ideas in which to perform environmentally-friendly actions. As another example, each time an accessory is connected to a connector 103, the interactive apparatus 100 uses an internal processor to recommend other actions, and displays those actions on the display screen of the interactive apparatus 100.

The actions suggested by the action-based indicia 203a-c may be non-sequential actions that may be performed by the user in any order determined by the user. For example, the user may turn off the light first, as provided for by the action-based indicium 203b, followed by recycling trash, as provided for by the action-based indicium 203c. Further, the action-based indicia 203a-c may equate to the number of predefined time intervals, which necessitates the user performing all of the action-based indicia 203a-c to complete the trait development associated with the interactive apparatus 100. Alternatively, the action-based indicia 203a-c may be greater in number than the number of predefined time intervals, thereby allowing the user to select a subset of the action-based indicia 203a-c that are preferred by the user.

Alternatively, the actions suggested by the action-based indicia 203a-c may be sequential actions that have to be performed according to a predetermined sequence. For example, the action-based indicia 203a-c may indicate a particular order for performing the corresponding actions. As a result, a trait-development sequence may be composed in a predetermined order to develop traits in a manner that increases in difficulty level and/or builds upon previously performed actions with subsequent actions that depend upon knowledge or skills developed from the previously performed actions. Further, with such a predetermined sequence, the interactive apparatus 100 may have various electronics componentry that outputs one or more validation indicia (e.g., talking voice, light emissions, buttons, sensors etc.) upon attachment of an accessory in the predetermined sequence, as determined by sensors associated with the connectors 105 illustrated in FIG. 1D; one or more non-validation indicia may be outputted upon an accessory being attached out-of-sequence to allow the user to perform an intermediate action.

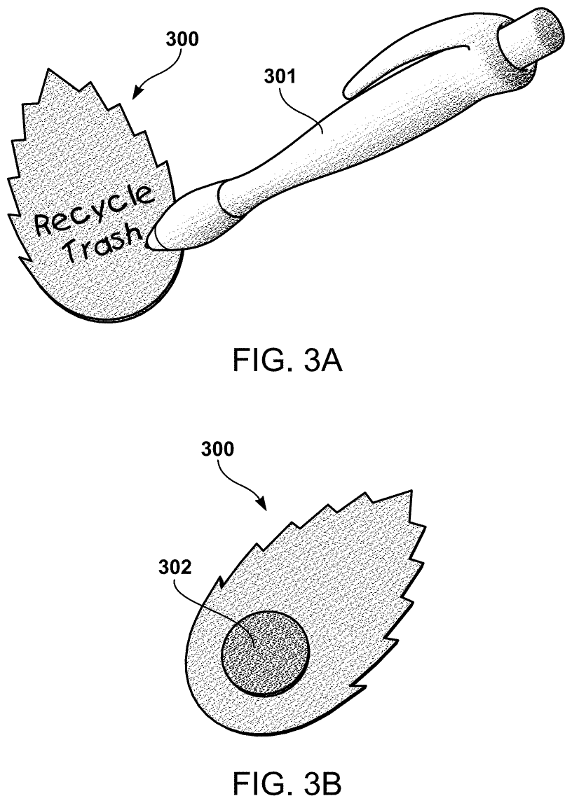

FIGS. 3A and 3B illustrate an example of an action-based accessory 300 that may be attached to a connector 103, as illustrated in FIG. 1D, upon completion of a task indicated by one of the action-based indicia 203a-c illustrated in FIG. 2. For example, FIG. 3A illustrates an example of the action-based accessory 300 being a leaf. In one embodiment, a user may perform a task indicated by one of the action-based indicia 203a-c, and may provide an indication on the action-based accessory 300 of the action that was performed. For example, upon viewing the action-based indicium 203a, the user may perform the task of recycling trash, and may use a writing implement 301 (e.g., pen, pencil, etc.) to indicate that action on the action-based accessory 300. In another embodiment, the action may be previously indicated on the action-based accessory 300 (e.g., predisposed text).

Further, as illustrated by FIG. 3B, the action-based accessory 300 may have a connector 302 that attaches to the connector 103 on the interactive apparatus 100. For example, the connector 302 may be a corresponding portion of a hook-and-loop fastener that adheres to the other portion of the hook-and-loop fastener that is part of the interactive apparatus 100. The connector 302 may be positioned on the rear of the action-based accessory 300 to allow for the action to be indicated on the front portion of the action-based accessory 300.

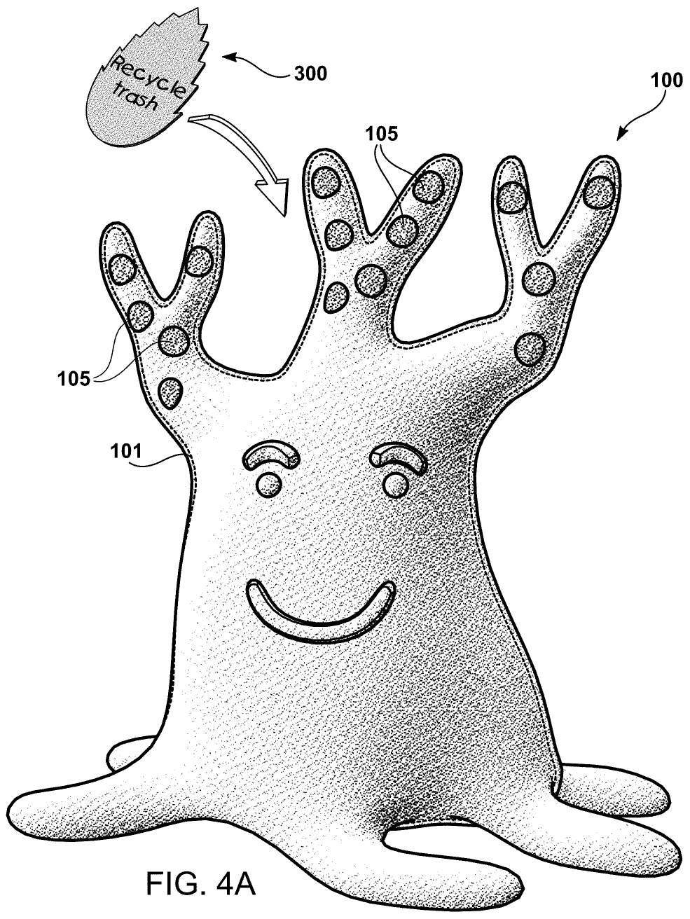

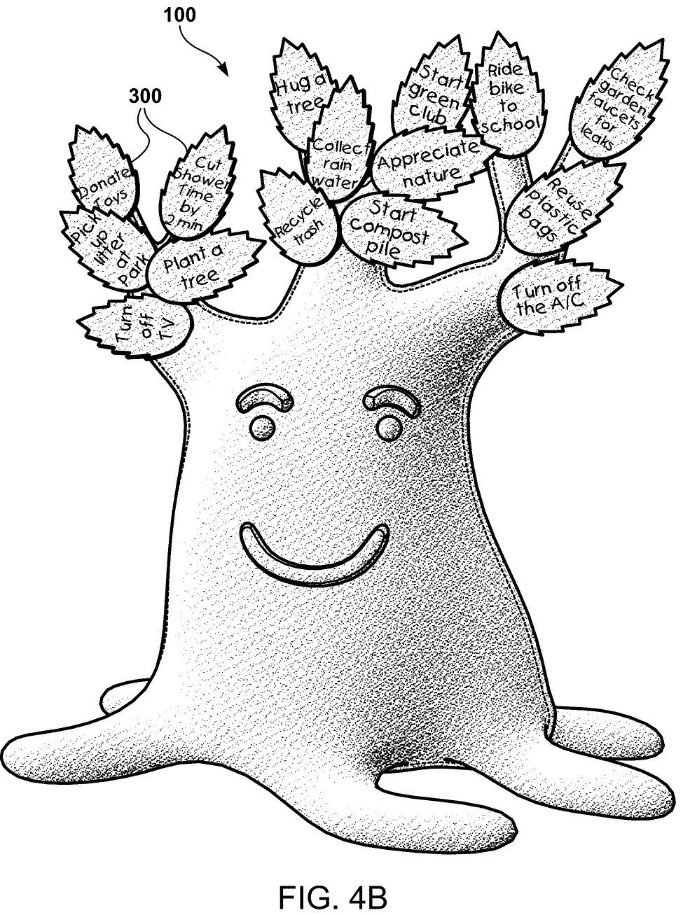

FIGS. 4A and 4B illustrate the action-based accessories 300 being adhered to the interactive apparatus 100 illustrated in FIG. 1D. For example, FIG. 4A illustrates the action-based accessory 300, in the form of a leaf, being adhered to a connector 105 on the interactive apparatus 100. Further, FIG. 4B illustrates all of the connectors 105 being adhered to corresponding action-based accessories, thereby indicating to the user completion of trait development (e.g., environmental awareness) associated with the particular interactive apparatus 100 over the predefined time interval (e.g., fifteen days).

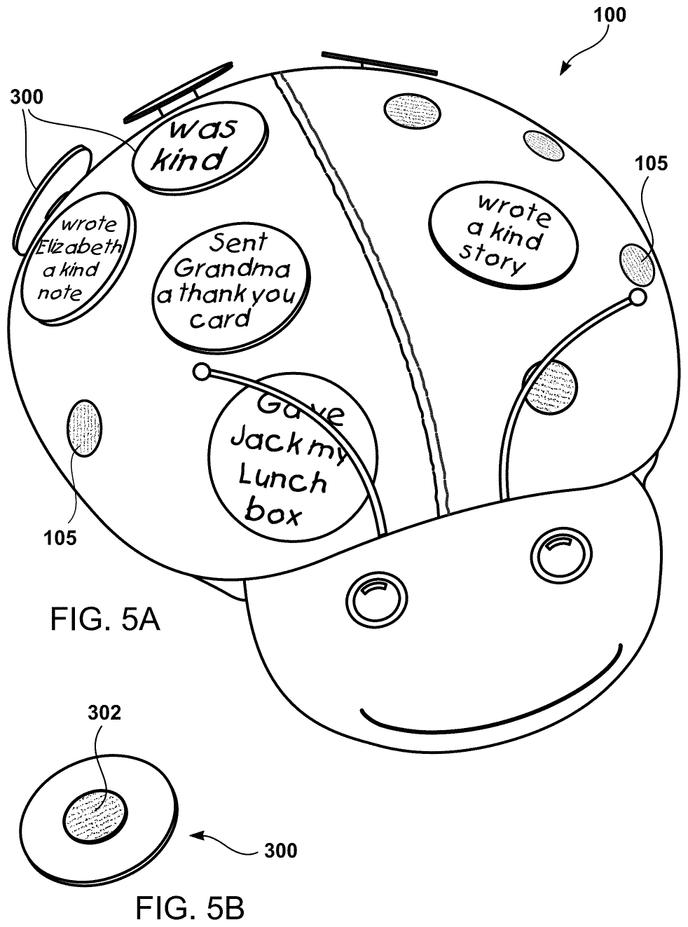

Although the interactive apparatus 100 is shaped in the form of a tree throughout FIGS. 1A-1D and 3A-4B, other organisms may be used for the interactive apparatus 100. FIGS. 5A and 5B illustrate an example of the interactive apparatus 100 being a lady bug. For example, the interactive apparatus 100 in the form of the lady bug may be associated with the trait of kindness. As illustrated in FIG. 5A, the lady bug may have one or more connectors 105 that attach to action-based accessories 300 in the form of attachable spots. FIG. 5B illustrates a connector 302 that may be positioned on the rear side of the action-based accessory 300.

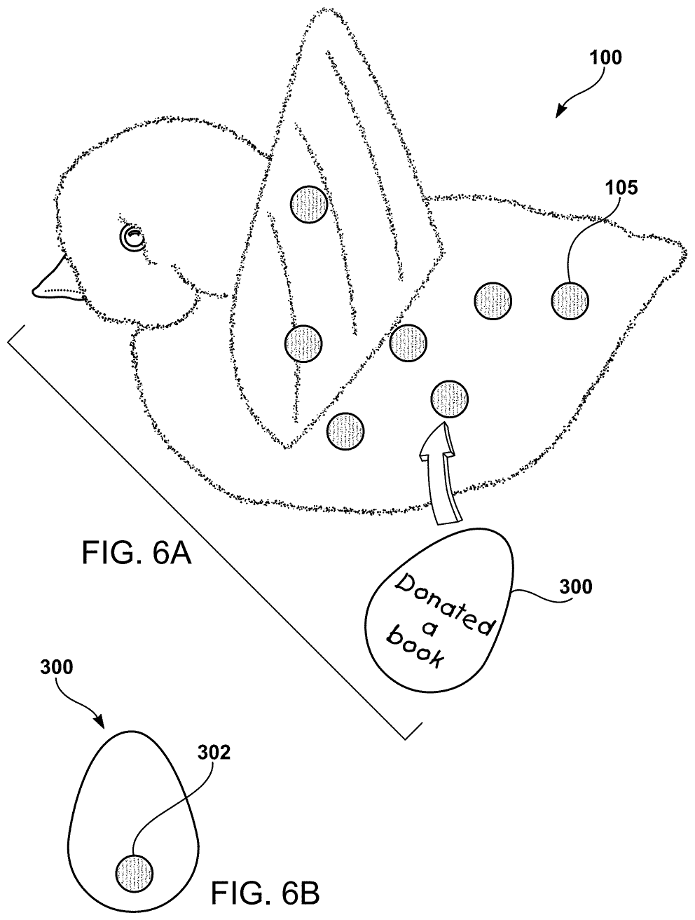

As yet another example, FIGS. 6A and 6B illustrate the interactive apparatus 100 being a chick. For example, the interactive apparatus 100 in the form of the chick may be associated with the trait of giving charity. FIG. 6A illustrates the interactive apparatus 100 having one or more connectors 105 underneath one or more wings. The connectors 105 attach to action-based accessories 300 in the form of eggs. FIG. 6B illustrates a connector 302 that may be positioned on the rear side of the action-based accessory 300.

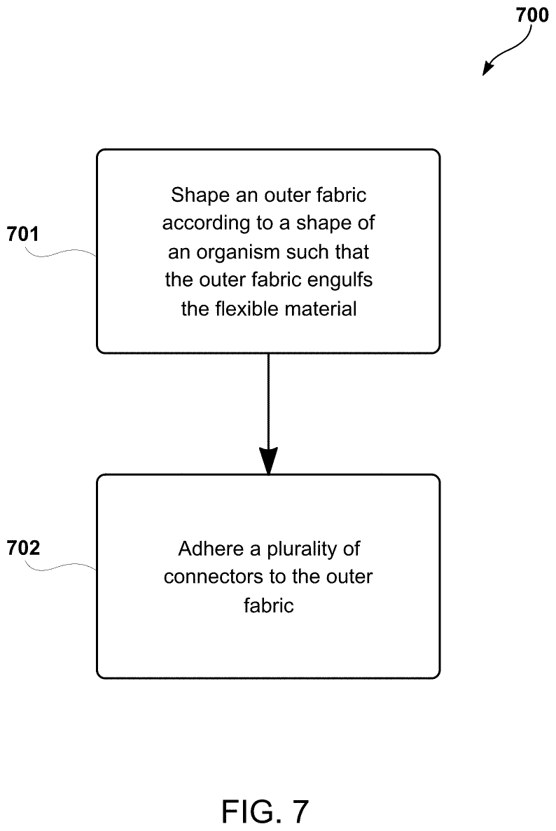

Additionally, FIG. 7 illustrates a process 700 that may be used to compose the interactive apparatus 100 illustrated in FIGS. 1A-1D and 3A-6B. At a process block 701, the process 700 shapes an outer fabric according to a shape of an organism such that the outer fabric engulfs the flexible material. Further, at a process block 702, the process 700 adheres a plurality of connectors to the outer fabric. Each of the plurality of connectors corresponds to a predefined time interval of a predefined time duration. Moreover, each of the plurality of connectors connects to one of a plurality of action-based accessories upon completion of a corresponding action. The predefined time interval, the predefined time duration, and the corresponding action are indicated by a plurality of action-based indicia. Further, the plurality of action-based indicia may be located remotely from the outer fabric.

The predefined time durations and predefined time intervals described herein are intended only as examples, since other predefined time durations and predefined time intervals may be used in conjunction with the interactive apparatus 100. Moreover, the interactive apparatus 100 may be shaped in the form of other organisms than that provided for herein.

It is understood that the apparatuses and processes described herein may also be applied in other types of apparatuses and processes. Those skilled in the art will appreciate that the various adaptations and modifications of the embodiments of the apparatuses and processes described herein may be configured without departing from the scope and spirit of the present apparatuses and processes. Therefore, it is to be understood that, within the scope of the appended claims, the present apparatuses and processes may be practiced other than as specifically described herein.

I claim:

1. An interactive apparatus comprising:
an outer fabric that forms a shape of an organism;
a flexible material engulfed by the outer fabric;
a plurality of connectors adhered to the outer fabric, each of the plurality of connectors corresponding to a predefined time interval of a predefined time duration, each of the plurality of connectors connecting to one of a plurality of action-based accessories upon completion of a corresponding action, wherein the predefined time interval, the predefined time duration, and the corresponding action are indicated by a plurality of action-based indicia, the plurality of action-based indicia being located remotely from the outer fabric.

2. The interactive apparatus of claim 1, wherein each of the plurality of connectors are sewn into the outer fabric.

3. The interactive apparatus of claim 1, wherein each of the plurality of connectors are glued to the outer fabric.

4. The interactive apparatus of claim 1, wherein each of the plurality of connectors comprises at least one portion of a hook-and-loop fastener to be fastened to a remaining portion of the hook-and-loop fastener that is operably attached to the corresponding one of the action-based accessories.

5. The interactive apparatus of claim 1, wherein the plurality of connectors comprises a plurality of clips.

6. The interactive apparatus of claim 1, wherein the outer fabric is selected from the group consisting of: plush, terrycloth, flannel, cotton, silk, corduroy, velvet, and polyester.

7. The interactive apparatus of claim 1, wherein the flexible material is selected from the group consisting of: synthetic fiber, polyester fiberfill, cotton, silk, and wool.

8. The interactive apparatus of claim 1, wherein the plurality of connectors is adhered to the outer fabric in a predefined arrangement.

9. The interactive apparatus of claim 1, wherein the plurality of action-based indicia are associated with a plurality of rules that restrict the plurality of action-based accessories from being connected via the plurality of connectors to the outer fabric unless the corresponding action has been completed remotely from the outer fabric.

10. The interactive apparatus of claim 1, wherein each of the plurality of action-based indicia are displayed on a tangible medium that is remotely situated from the outer fabric.

11. The interactive apparatus of claim 1, wherein the plurality of action-based indicia comprise imagery indicative of the corresponding action.

12. The interactive apparatus of claim 1, wherein the plurality of action-based indicia comprise text indicative of the corresponding action.

13. A method comprising:
shaping an outer fabric according to a shape of an organism such that the outer fabric engulfs the flexible material; and
adhering a plurality of connectors to the outer fabric, each of the plurality of connectors corresponding to a predefined time interval of a predefined time duration, each of the plurality of connectors connecting to one of a plurality of action-based accessories upon completion of a corresponding action, wherein the predefined time interval, the predefined time duration, and the corresponding action are indicated by a plurality of action-based indicia, the plurality of action-based indicia being located remotely from the outer fabric.

14. The method of claim 13, further comprising shaping the plurality of action-based accessories according to a shape of an anatomical part of the organism.

15. The method of claim 13, wherein the plurality of action-based accessories is composed of foam.

16. The method of claim 13, further comprising displaying each of the plurality of action-based on a tangible medium that is remotely situated from the outer fabric.

17. The method of claim 13, further comprising adhering each of the plurality of connectors into the outer fabric by sewing the plurality of connectors into the outer fabric.

18. The method of claim 13, further comprising adhering each of the plurality of connectors into the outer fabric by gluing the plurality of connectors into the outer fabric.

19. The method of claim 13, wherein each of the plurality of connectors comprises at least one portion of a hook-and-loop fastener to be fastened to a remaining portion of the hook-and-loop fastener that is operably attached to the corresponding one of the action-based accessories.

20. The method of claim 13, further comprising adhering the plurality of connectors to the outer fabric in a predefined arrangement.
